(19) United States
(12) Patent Application Publication
(10) Pub. No.: US 2025/0278034 A1
(43) Pub. Date: Sep. 4, 2025

(54) EXTERNAL ADDITIVE FOR TONER AND TONER

(71) Applicant: CANON KABUSHIKI KAISHA, Tokyo (JP)

(72) Inventors: MARI KABURAGI, Chiba (JP); ICHIRO KANNO, Chiba (JP); YUKIHIRO ABE, Chiba (JP); JUNICHI TAMURA, Ibaraki (JP); HAYATO IDA, Ibaraki (JP); KEI INOUE, Kanagawa (JP); MASAO SUZUKI, Kanagawa (JP); WAKA HASEGAWA, Tokyo (JP)

(21) Appl. No.: 19/209,545

(22) Filed: May 15, 2025

Related U.S. Application Data
(63) Continuation of application No. PCT/JP2023/039558, filed on Nov. 2, 2023.

(30) Foreign Application Priority Data
Nov. 17, 2022 (JP) 2022-183914
Oct. 12, 2023 (JP) 2023-176393

(51) Int. Cl. G03G 9/097; G03G 9/08

(52) U.S. Cl. CPC G03G 9/09783; G03G 9/0819; G03G 9/09708

(57) ABSTRACT

An external additive includes fine particles A that contain an organosilicon compound with a siloxane bond as a binder component and have fine particles B. The fine particles B are present at the surface of the fine particles A in a state at least partially embedded in the surface of the fine particles A. The external additive has a number average diameter of primary particles of 0.03 μm or more and 0.30 μm or less. The ratio BD/AD of the number average diameter BD of primary particles of the fine particles B to the number average diameter AD of primary particles of the fine particles A is 0.05 or more and 0.70 or less. The fine particles B have a volume resistivity of 1.0×10⁵ Ω·cm or more and 1.0×10¹³ Ω·cm or less and have an embedding rate of 30% or more and 90% or less.

### CROSS-REFERENCE TO RELATED APPLICATIONS

This application is a Continuation of International Patent Application No. PCT/JP2023/039558, filed Nov. 2, 2023, which claims the benefit of Japanese Patent Application No. 2022-183914, filed Nov. 17, 2022 and No. 2023-176393, filed Oct. 12, 2023, all of which are hereby incorporated by reference herein in their entirety.

### TECHNICAL FIELD

The present invention relates to an external additive for toner and a toner using the external additive.

### BACKGROUND ART

As electrophotographic full-color copiers have been widely used, toners used in electrophotography are increasingly demanded to support high-speed printing and have a longer life.

A known approach to increasing the durability of toner uses fine particles containing organosilicon as an external additive (PTLs 1 and 2). However, the fine particles containing organosilicon do not easily release electric charge in low-humidity environments and increase their electrostatic adhesion with increasing electrical charge. This leads to changes in electrical charge in low-humidity environments, resulting in reduced uniformity in image density over extended periods of use.

For this issue, a method to composite organosilicon and low-resistance fine particles has been known (PTL 3). Also, there is an example in which resin particles and low-resistance fine particles were composited (PTL 4).

### CITATION LIST

### Patent Literature

1 Japanese Patent No. 6116711

PTL 2 Japanese Patent Laid-Open No. 2018-4949

PTL 3 Japanese Patent Laid-Open No. 2016-163866

PTL 4 Japanese Patent No. 5982003

When organosilicon fine particles and low-resistance fine particles are mixed to be composited, as disclosed in PTL 3, the amount of charge is expected to decrease while the low-resistance fine particles are attached to the surface of the organosilicon fine particle. Unfortunately, the binding between organosilicon fine particles and low-resistance fine particles is weak. If the toner remains in contact with carriers or other component members for a long period, the low-resistance fine particles detach from the surface of the organosilicon fine particles, diminishing the effect of suppressing the increase in the amount of charge.

In addition, when resin particles and low-resistance fine particles are composited, as disclosed in PTL 4, while the amount of charge does not increase in low-humidity environments, the toner has an issue with durability.

### SUMMARY OF INVENTION

It is an object of the present invention to provide an external additive for toner and a toner that solve the above issues, and specifically, to provide an external additive and a toner that can reduce changes in charge in low-humidity environments and suppress the increase in electrostatic adhesion.

The present invention provides an external additive for toner. The external additive for toner includes fine particles A that contain an organosilicon compound with a siloxane bond as a binder component and have fine particles B. The fine particles B are present at the surface of the fine particles A in a state at least partially embedded in the surface of the fine particles A. The external additive has a number average diameter of primary particles of 0.03 μm or more and 0.30 μm or less. The fine particles A contain units (a), (b), and (c), presented below, in proportions satisfying the following relationships (1) and (2) relative to all of the silicon atoms in the fine particles A, on a number basis:

$$( a ) + ( b ) + ( c ) \geq 0.8 \qquad ( 1 )$$

$$( b ) + ( c ) \geq 0.3 \qquad ( 2 )$$

The ratio BD/AD of the number average diameter BD of primary particles of the fine particles B to the number average diameter AD of primary particles of the fine particles A is 0.05 or more and 0.70 or less. The fine particles B have a volume resistivity of 1.0×10⁵ Ω·cm or more and 1.0×10¹³ Ω·cm or less and have an embedding rate, expressed as the following equation, of 30% or more and 90% or less on average:

$$Embedding rate ( \% ) of fine particles B = ( depth of fine particles B embedded in fine particles A / diameter of fine particles B ) \times 100$$

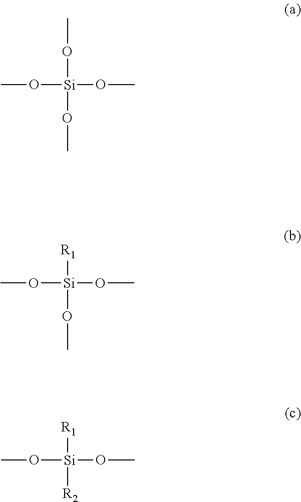

wherein R₁ and R₂ each independently represent an alkyl group with 1 to 6 carbon atoms.

The present invention also relates to a toner including toner particles and an external additive. The external additive is that described above.

Further features of the present invention will become apparent from the following description of exemplary embodiments.

### DESCRIPTION OF EMBODIMENTS

In the description presented herein, numerical ranges expressed as “** or more and xx or less” or “** to xx” each include the lower and the upper limit being the values at the ends of the range unless otherwise specified.

The present inventors believe that the mechanism of producing the advantageous effects of the present invention is as follows.

When fine particles containing organosilicon are used as an external additive, the external additive is less likely to be embedded in the toner because the organosilicon-containing fine particles have more moderate elasticity than silica, which is generally used as an external additive. Thus, the toner can exhibit good durability. However, the fine particles containing organosilicon are less likely to leak charge in low-humidity environments and increase their electrostatic adhesion with an increasing amount of charge.

In contrast, forming composite particles by embedding low-resistance particles in the surface of fine particles containing organosilicon creates a leakage path for charges, thus suppressing the increase in the amount of charge in low-humidity environments. Since the low-resistance particles are embedded in the surface of the fine particles containing organosilicon, the low-resistance particles are unlikely to detach. The inventors believe that this continues to suppress the increase in the amount of charge and thus reached the present invention.

### External Additive

The number average diameter of primary particles of the external additive of the present invention is 0.03 μm or more and 0.30 μm or less. When the number average diameter of the primary particles is in such a range, the fine particles can evenly cover the toner particles. When the number average diameter of primary particles of the fine particles is less than 0.03 μm, prolonged output of a large number of images with low print density can increase the stress on the toner. Consequently, the particles of the external additive may be embedded in the surface of the toner particles, increasing electrostatic adhesion. When the number average diameter of primary particles of the fine particles exceeds 0.30 μm, the particles of the external additive detach from the surface of the toner. Consequently, electrostatic adhesion may become likely to increase.

The number average diameter of primary particles of the external additive can be increased by lowering the reaction temperature, shortening the reaction time, or increasing the amount of catalyst in the hydrolysis and condensation steps. Also, the number average diameter of primary particles of the fine particles can be reduced by raising the reaction temperature, lengthening the reaction time, or reducing the amount of catalyst in the hydrolysis and condensation steps.

From this viewpoint, the number average diameter of primary particles of the external additive is preferably 0.07 μm or more and 0.20 μm or less, specifically, 0.08 μm or more and 0.15 μm or less.

The proportions of the amounts of the following units (a), (b), and (c) relative to all of the silicon atoms in the fine particles A satisfy the following relationships (1) and (2):

$$( a ) + ( b ) + ( c ) \geq 0.8 \qquad ( 1 )$$

$$( b ) + ( c ) \geq 0.3 \qquad ( 2 )$$

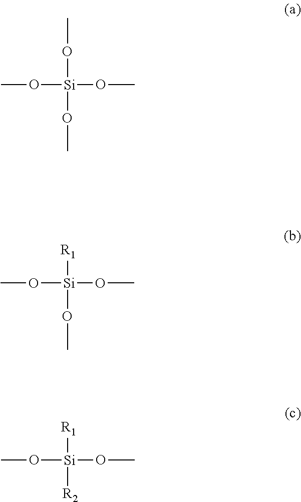

wherein R₁ and R₂ each independently represent an alkyl group with 1 to 6 carbon atoms.

In such proportions, the fine particles A themselves are difficult to break even when the toner receives stress from the carrier or other component members, and have moderate flexibility. Consequently, the organosilicon compound functions as a binder component for the fine particles B to maintain the initial state of the embedded fine particles B. The proportions of the amounts of the above units (a), (b), and (c) can be controlled by the amounts of silane monomers forming the units.

The ratio BD/AD of the number average diameter BD of primary particles of the fine particles B to the number average diameter AD of primary particles of the fine particles A is 0.05 or more and 0.70 or less. When BD/AD is in this range, the charge on the fine particles A can be moderately released through the fine particles B in low-humidity environments, thus suppressing the increase in the amount of charge. A BD/AD value of less than 0.05 indicates that the fine particles B are excessively smaller than the fine particles A and, therefore, charge is difficult to release. A BD/AD value of more than 0.70 indicates that the fine particles B are excessively larger than the fine particles A and easy to detach from the fine particles A when stressed by the component members. Consequently, the increase in the amount of charge in low-humidity environments is not suppressed effectively. The number average diameter of primary particles of the fine particles A can be controlled by controlling the reaction conditions in the hydrolysis and condensation steps as described above. The number average diameter of primary particles of the fine particles B can be controlled by the selection of the fine particles added. The preferred range of the BD/AD value is 0.10 or more and 0.50 or less, more preferably 0.15 or more and 0.30 or less.

The volume resistivity of the fine particles B is 1.0×10⁵ Ω·cm or more and 1.0×10¹³ Ω·cm or less. When the volume resistivity is in this range, the charge on the fine particles A can be moderately released through the fine particles B in low-humidity environments, thus suppressing the increase in the amount of charge. When the volume resistivity is less than 1.0×10⁵ Ω·cm, the charge attenuates in high-temperature, high-humidity environments, resulting in degraded chargeability. When the volume resistivity is more than 1.0×10¹³ Ω·cm, the charge is not released sufficiently in low-humidity environments, and hence, the increase in the amount of charge is not suppressed effectively. The preferred range of the volume resistivity is 1.0×10⁶ Ω·cm or more and 1.0×10¹² Ω·cm or less, more preferably 1.0×10⁷ Ω·cm or more and 1.0×10¹¹ Ω·cm or less.

In the external additive of the present invention, the fine particles B has an embedding rate, expressed as the following equation, of 30% or more and 90% or less on average:

$$Embedding rate ( \% ) of fine particles B = ( depth of the fine particles B embedded in fine particles A / diameter of fine particles B ) \times 100$$

When the embedding rate is 30% or more and 90% or less, the fine particles B are less likely to detach from the fine particles A even when stressed by the component members, thus suppressing the increase in the amount of charge in low-humidity environments effectively. When the embedding rate is less than 30%, the fine particles B easily detach from the fine particles A when stressed by the component members. Consequently, the increase in the amount of charge in low-humidity environments is not suppressed effectively. When the embedding rate is more than 90%, the charge attenuates in high-temperature, high-humidity environments, resulting in degraded chargeability.

The embedding rate of the fine particles B can be controlled by the time and temperature of the reaction with silane monomers that form the above-described units. More specifically, for reducing the embedding rate, the time or temperature of the reaction between the monomers and the fine particles B may be reduced. For increasing the embedding rate, the time or temperature of the reaction between the monomers and the fine particles B may be increased. The preferred range of the embedding rate is 40% or more and 80% or less, more preferably 45% or more and 70% or less.

The measurement methods of the above-mentioned physical properties will be described later.

### Production Method

Preferably, the external additive of the present invention is produced through, but not limited to, hydrolysis and condensation polymerization reactions of silicon compounds (silane monomers) using a sol-gel method. More specifically, a mixture of bifunctional silane, which has two siloxane bonds, and tetrafunctional silane, which has four siloxane bonds, is subjected to hydrolysis and condensation polymerization, and the resulting system is allowed to react with low-resistance fine particles or the like to form composite particles. Silane monomers, including bifunctional silane and tetrafunctional silane, will be described later. The proportion of bifunctional silane is preferably 30 mol % or more and 70 mol % or less, more preferably 40 mol % or more and 60 mol % or less. The proportion of tetrafunctional silane is preferably 30 mol % or more and 80 mol % or less, more preferably 40 mol % or more and 70 mol % or less.

The external additive of the present invention includes particles (fine particles A) as the major component that contains an organosilicon compound with a siloxane bond as a binder component.

The organosilicon compound may be produced by any process without limitation. For example, a silane compound dropped in water is subjected to hydrolysis and condensation in the presence of a catalyst, and the resulting suspension is filtered and dried to yield an organosilicon compound. The particle diameter can be controlled by varying the type and amount of the catalyst, the temperature at which the reaction starts, the time of dropping, and other factors. Examples of the catalyst include, but are not limited to, acid catalysts, such as hydrochloric acid, hydrofluoric acid, sulfuric acid, and nitric acid; and basic catalysts, such as ammonia water, sodium hydroxide, and potassium hydroxide.

Preferably, the organosilicon compound is produced by the following method. Specifically, the method preferably includes a first step of producing a hydrolysate of a silicon compound, a second step of mixing the hydrolysate, an alkaline aqueous medium, and a dispersion liquid of low-resistance particles for a polycondensation reaction of the hydrolysate and a subsequent reaction with the low-resistance particles, and a third step of mixing the polycondensation product with an aqueous solution to form particles. In some cases, a hydrophobizing agent may be further added.

In the first step, an acid or alkaline material that acts as a catalyst is dissolved in water, and in this solution, a silicon compound is brought into contact with the catalyst by stirring, blending, or the like. A known catalyst may be suitably used as the catalyst. Examples of the catalyst include acid catalysts, such as acetic acid, hydrochloric acid, hydrofluoric acid, sulfuric acid, and nitric acid; and basic catalysts, such as ammonia water, sodium hydroxide, and potassium hydroxide.

The amount of catalyst can be adjusted according to the types of the silicon compound and the catalyst. For example, it may be 1×10⁻³ parts by mass or more and 1 part by mass or less relative to 100 parts by mass of water used for hydrolyzing the silicon compound.

When the amount of catalyst is 1×10⁻³ parts by mass or more, the reaction proceeds sufficiently. In contrast, when the amount of catalyst is 1 part by mass or less, the concentration of the catalyst remaining as an impurity among the fine particles is reduced, facilitating the hydrolysis. The amount of water may be 2 mol or more and 15 mol or less relative to 1 mol of the silicon compound. When the amount of water is 2 mol or more, the hydrolysis proceeds sufficiently, and when it is 15 mol or less, the productivity increases.

The reaction may be performed at room temperature or under heating conditions without limiting the reaction temperature. However, the reaction temperature is preferably kept at 10° C. to 60° C. because hydrolysate can be obtained in a short time and the partial condensation of the hydrolysate can be reduced. The reaction time is not particularly limited and can be determined as appropriate in consideration of the reactivity of the silicon compound used, the composition of the reaction liquid containing the silicon compound, acid, and water, and productivity.

In the second step of the method for producing the organosilicon compound, the raw material solution obtained in the first step is mixed with an alkaline aqueous medium to perform a polycondensation reaction of a particle precursor, thus obtaining a polycondensed liquid. The alkaline aqueous medium is prepared by mixing an alkaline component, water, and optionally, an organic solvent or the like.

The alkaline component used in the alkaline aqueous medium, which is a substance whose aqueous solution is basic, acts as a neutralizer for the catalyst used in the first step and as a catalyst for the polycondensation reaction in the second step. Examples of the alkaline component include alkali metal hydroxides, such as lithium hydroxide, sodium hydroxide, and potassium hydroxide; ammonia; and organic amines, such as monomethylamine and dimethylamine.

The amount of the alkaline component is determined so that the alkaline component can neutralize the acid and act effectively as a catalyst for the polycondensation reaction. For example, in the case of using ammonia as the alkaline component, ammonia is used in an amount of 0.01 part by mass or more and 12.5 parts by mass or less relative to 100 parts by mass of the mixture of water and organic solvent.

In the second step, an organic solvent may also be used in addition to the alkaline component and water to prepare the alkaline aqueous medium. Any organic solvent can be used without limitation as long as it is compatible with water, but organic solvents that dissolve at least 10 g of water in 100 g at room temperature and under normal pressure are suitable.

More specifically, such organic solvents include alcohols, such as methanol, ethanol, n-propanol, 2-propanol, and butanol; polyhydric alcohols, such as ethylene glycol, diethylene glycol, propylene glycol, glycerin, trimethylolpropane, and hexanetriol; ethers, such as ethylene glycol monoethyl ether, acetone, diethyl ether, tetrahydrofuran, and diacetone alcohol; and amide compounds, such as dimethylformamide, dimethylacetamide, and N-methylpyrrolidone.

Among these organic solvents, alcohols, such as methanol, ethanol, 2-propanol, and butanol, are favorable. From the viewpoint of hydrolysis and dehydration condensation reactions, the same alcohol as the alcohol produced by elimination is preferred as the organic solvent.

In the third step, the polycondensation product obtained in the second step is mixed with an aqueous solution to form particles. The aqueous solution may be water (tap water, pure water, etc.), and further constituents compatible with water, such as a salt, an acid, an alkali, an organic solvent, a surfactant, a water-soluble polymer, may be added to water. The temperature of the polycondensed liquid and aqueous solution when mixed may be, but is not limited to, 5° C. to 70° C. in view of their compositions and productivity.

For collecting the resulting particles, any known method may be used without particular limitation. For example, the particles may be collected by scooping floating powder or filtration. Filtration is preferred because of its simple operation. The filtration may be performed by, but not limited to, vacuum filtration, centrifugal filtration, or pressure filtration using known devices. The filter used for the filtration may be a filter paper, a filter cloth, or any other type of filter and can be selected, without particular limitation, from industrially available filters as appropriate for the device used.

The monomers to be used may be selected as appropriate according to compatibility with the solvent and catalyst, hydrolyzability, and other properties. Examples of the tetrafunctional silane monomer having the above structure (a) include tetramethoxysilane, tetraethoxysilane, and tetraisocyanatosilane. Among these, tetraethoxysilane is preferred.

Examples of the trifunctional silane monomer having the above structure (b) include methyltrimethoxysilane, methyltriethoxysilane, methyldiethoxymethoxysilane, methylethoxydimethoxysilane, methyltrichlorosilane, methylmethoxydichlorosilane, methylethoxydichlorosilane, methyldimethoxychlorosilane, methylmethoxyethoxychlorosilane, methyldiethoxychlorosilane, methyltriacetoxysilane, methyldiacetoxymethoxysilane, methyldiacetoxyethoxysilane, methylacetoxydimethoxysilane, methylacetoxymethoxyethoxysilane, methylacetoxydiethoxysilane, methyltrihydroxysilane, methylmethoxydihydroxysilane, methylethoxydihydroxysilane, methyldimethoxyhydroxysilane, methylethoxymethoxyhydroxysilane, methyldiethoxyhydroxysilane, ethyltrimethoxysilane, ethyltriethoxysilane, ethyltrichlorosilane, ethyltriacetoxysilane, ethyltrihydroxysilane, propyltrimethoxysilane, propyltriethoxysilane, propyltrichlorosilane, Propyltriacetoxysilane, propyltrihydroxysilane, butyltrimethoxysilane, butyltriethoxysilane, butyltrichlorosilane, butyltriacetoxysilane, butyltrihydroxysilane, hexyltrimethoxysilane, hexyltriethoxysilane, hexyltrichlorosilane, hexyltriacetoxysilane, hexyltrihydroxysilane, phenyltrimethoxysilane, phenyltriethoxysilane, phenyltrichlorosilane, phenyltriacetoxysilane, and phenyltrihydroxysilane. Among these, methyltrimethoxysilane is preferred.

Examples of the bifunctional silane monomer having the above structure (c) include di-tert-butyldichlorosilane, di-tert-butyldimethoxysilane, di-tert-butyldiethoxysilane, dibutyldichlorosilane, dibutyldimethoxysilane, dibutyldiethoxysilane, dichlorodecylmethylsilane, dimethoxydecylmethylsilane, diethoxydecylmethylsilane, dichlorodimethylsilane, dimethoxydimethylsilane, diethoxydimethylsilane, and diethyldimethoxysilane. Among these, dimethyldimethoxysilane is preferred.

### Fine Particles B

The fine particles B are preferably selected from among titanium oxide fine particles, strontium titanate fine particles, and zinc oxide fine particles. When the fine particles B are selected from these, the charge on the fine particles A can be moderately released through the fine particles B in low-humidity environments, thus suppressing the increase in the amount of charge.

### Other Physical Properties of External Additive

The true specific gravity of the external additive of the present invention is preferably 1.00 g/cm³ or more and 1.60 g/cm³ or less. When the true specific gravity is in this range, the amount of fine particles B relative to fine particles A is appropriate, and therefore, charge on the fine particles A can be moderately released in low-humidity environments, thus suppressing the increase in the amount of charge. The true specific gravity can be controlled by varying the type, amount, or embedding rate of fine particles B. From this viewpoint, the true specific gravity is preferably 1.20 g/cm³ or more and 1.40 g/cm³ or less.

The dielectric constant of the external additive of the present invention is preferably 10 pF/m or more and 40 pF/m or less at 2 kHz. When the dielectric constant is in this range, charge attenuation in high-temperature, high-humidity environments can be inhibited, accordingly reducing the degradation of chargeability. The dielectric constant can be controlled by varying the type, amount, or embedding rate of fine particles B. From this viewpoint, the dielectric constant is preferably 20 pF/m or more and 30 pF/m or less.

The external additive of the present invention is preferably surface treated with a hydrophobizing agent. Hence, the fine particles A are preferably silicon polymer particles surface treated with a hydrophobizing agent. The hydrophobizing agent is preferably, but is not limited to, an organosilicon compound.

Examples include alkylsilazane compounds, such as hexamethyldisilazane; alkylalkoxysilane compounds, such as diethyldiethoxysilane, trimethylmethoxysilane, methyltrimethoxysilane, and butyltrimethoxysilane; fluoroalkylsilane compounds, such as trifluoropropyltrimethoxysilane; chlorosilane compounds, such as dimethyldichlorosilane and trimethylchlorosilane; siloxane compounds, such as octamethylcyclotetrasiloxane; and silicone oil and silicone varnish.

The hydrophobizing agent at the surface of the fine particles of the external additive stabilizes the chargeability in low-humidity environments or high-temperature, high-humidity environments. In particular, the fine particles of the external additive are surface treated, preferably with at least one compound selected from the group consisting of alkylsilazane compounds, alkylalkoxysilane compounds, chlorosilane compounds, siloxane compounds, and silicone oil. More preferably, the fine particles A are surface treated with an alkylsilazane compound from the above-mentioned viewpoint.

In an electron micrograph of a cross section of the external additive of the present invention taken using a transmission electron microscope, the average of Sb/Sa values of 100 fine particles A is preferably 0 or more and 0.50 or less, wherein Sa denotes the area of the cross section X of an individual fine particle A, and Sb denotes the total area of the fine particles B fully contained within the cross section X without being exposed outside. When the average Sb/Sa value is in this range, charge attenuation in high-temperature, high-humidity environments can be inhibited, accordingly reducing the degradation of chargeability. The Sb/Sa value can be controlled by the amount of fine particles B added and the time and temperature of the reaction of the fine particles B with the monomers forming the fine particles A. From the above-mentioned viewpoint, the average of Sb/Sa values is preferably 0 or more and 0.30 or less.

The proportions of the amounts of the above units (a), (b), and (c) in the fine particles A of the external additive of the present invention preferably satisfy the following relationships (I), (II), and (III):

$$0.3 \leq ( a ) / ( ( a ) + ( b ) + ( c ) ) \leq 0.7 \qquad ( I )$$

$$0 \leq ( b ) / ( ( a ) + ( b ) + ( c ) ) \leq 0.5 \qquad ( II )$$

$$0.2 \leq ( c ) / ( ( a ) + ( b ) + ( c ) ) \leq 0.7 \qquad ( III )$$

In such proportions, the fine particles themselves A are difficult to break even when the toner receives stress from the carrier or other component members, and have moderate flexibility. Consequently, the initial state of the embedded fine particles B can be maintained. Furthermore, the following relationships are more preferable:

$$0.4 \leq ( a ) / ( ( a ) + ( b ) + ( c ) ) \leq 0.7 \qquad ( {I}^{′} )$$

$$0 \leq ( b ) / ( ( a ) + ( b ) + ( c ) ) \leq 0.1 \qquad ( {II}^{′} )$$

$$0.3 \leq ( c ) / ( ( a ) + ( b ) + ( c ) ) \leq 0.6 \qquad ( {III}^{′} )$$

In such proportions, the amount of Si—R present in the external additive is optimal and thus more favorable.

Also, in the fine particles A containing an organosilicon compound with a siloxane bond as a binder component, preferably, the proportions of the amounts of the above units (a), (b), and (c) satisfy the following relationship (IV):

$$0.95 \leq ( ( a ) + ( c ) ) / ( ( a ) + ( b ) + ( c ) ) \qquad ( IV )$$

In such proportions, the fine particles A themselves are difficult to break even when the toner receives stress from the carrier or other component members, and have moderate flexibility. Consequently, the initial state of the embedded fine particles B can be maintained.

The amount of the external additive of the present invention is preferably 0.1 part by mass or more and 20.0 parts by mass or less relative to 100 parts by mass of the toner particles from the viewpoint of charging stability. More preferably, it is 0.5 part by mass or more and 15.0 parts by mass or less. Still more preferably, it is 1.0 part by mass or more and 10.0 parts by mass or less.

When the amount of the external additive is less than 0.1 part by mass, the stress placed on the toner cannot be controlled in prolonged output of a large number of images with low print density in severe environments, such as in high-temperature, high-humidity environments. Consequently, stability in duration is less likely to be obtained. When the amount of the external additive exceeds 20.0 parts by mass, filming of the external additive can occur on the carrier, the charging member, and the photosensitive member in prolonged output of images.

### Toner Particles

The constituents of the toner particles to which the external additive is externally added will now be described in detail.

### Binder Resin

The binder resin used in the toner of the present invention may be, but is not limited to, any of the following polymers or resins.

Examples include homopolymers of styrene or substituted styrene, such as polystyrene, poly-p-chlorostyrene, and polyvinyl toluene; styrene copolymers, such as styrene-p-chlorostyrene copolymer, styrene-vinyl toluene copolymer, styrene-vinyl naphthalene copolymer, styrene-acrylic acid ester copolymer, styrene-methacrylic acid ester copolymer, styrene-methyl α-chloromethacrylate copolymer, styrene-acrylonitrile copolymer, styrene-vinyl methyl ether copolymer, styrene-vinyl ethyl ether copolymer, styrene-vinyl methyl ketone copolymer, and styrene-acrylonitrile-indene copolymer; and polyvinyl chloride, phenolic resin, natural resin-modified phenolic resin, natural resin-modified maleic resin, acrylic resin, methacrylic resin, polyvinyl acetate, silicone resin, polyester resin, polyurethane, polyamide resin, furan resin, epoxy resin, xylene resin, polyvinyl butyral, terpene resin, coumarone-indene resin, and petroleum-based resin. Among these, polyester resin is preferred from the viewpoint of durability, stability, and charging stability.

The polyester resin preferably has an acid value of 0.5 mg KOH/g or more and 40 mg KOH/g or less from the viewpoint of environmental stability and charging stability. When the acid value is in such a range, the interaction of the acid group with the Si—R in the fine particles A can further improve the durability and the chargeability of the toner in high-temperature, high-humidity environments. More preferably, the acid value is 1 mg KOH/g or more and 20 mg KOH/g or less, still more preferably 1 mg KOH/g or more and 15 mg KOH/g or less.

### Coloring Agent

The toner of the present invention may contain a coloring agent as needed. The following coloring agents may be used.

The black coloring agent may be carbon black or a mixture whose color is adjusted to black using yellow, magenta, and cyan coloring agents. The coloring agent may be pigment alone or a combination of pigment and dye. From the viewpoint of the image quality of full-color images, using a combination of dye and pigment is preferable to enhance definition.

Pigments for magenta toner include C.I. Pigment Reds 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, 269, and 282; C.I. Pigment Violet 19; and C.I. Vat Reds 1, 2, 10, 13, 15, 23, 29, and 35.

Dyes for magenta toner include oil-soluble dyes, such as C.I. Solvent Reds 1, 3, 8, 23, 24, 25, 27, 30, 49, 81, 82, 83, 84, 100, 109, and 121, C.I. Disperse Red 9, C.I. Solvent Violets 8, 13, 14, 21, and 27, and C.I. Disperse Violet 1; and basic dyes, such as C.I. Basic Reds 1, 2, 9, 12, 13, 14, 15, 17, 18, 22, 23, 24, 27, 29, 32, 34, 35, 36, 37, 38, 39, and 40, and C.I. Basic Violets 1, 3, 7, 10, 14, 15, 21, 25, 26, 27, and 28.

Pigments for cyan toner include C.I. Pigment Blues 2, 3, 15:2, 15:3, 15:4, 16, and 17; C.I. Vat Blue 6; C.I. Acid Blue 45; and copper phthalocyanine pigment having a phthalocyanine skeleton substituted with 1 to 5 phthalimidomethyl groups.

An example of a dye for cyan toner is C.I. Solvent Blue 70.

Pigments for yellow toner include C.I. Pigment Yellows 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, and 185; and C.I. Vat Yellows 1, 3, and 20.

An example of a dye for yellow toner is C.I. Solvent Yellow 162.

The amount of the coloring agent may be 0.1 part by mass or more and 30.0 parts by mass or less relative to 100 parts by mass of the binder resin.

### Wax

The toner of the present invention may contain wax as needed. The wax is, for example, as follows.

Examples include hydrocarbon-based wax, such as microcrystalline wax, paraffin wax, and Fischer-Tropsch wax; oxides of hydrocarbon waxes, such as oxidized polyethylene wax, or their block copolymers; waxes mainly containing a fatty acid ester, such as carnauba wax; and partially or fully deoxidized fatty acid esters, such as deoxidized carnauba wax.

Further compounds that can be used include saturated linear fatty acids, such as palmitic acid, stearic acid, and montanic acid; unsaturated fatty acids, such as brassidic acid, eleostearic acid, and parinaric acid; saturated alcohols, such as stearyl alcohol, aralkyl alcohol, behenyl alcohol, carnaubyl alcohol, ceryl alcohol, and melissyl alcohol; polyhydric alcohols, such as sorbitol; esters of a fatty acid, such as palmitic acid, stearic acid, behenic acid, or montanic acid, with an alcohol, such as stearyl alcohol, aralkyl alcohol, behenyl alcohol, carnaubyl alcohol, ceryl alcohol, or melissyl alcohol; fatty acid amides, such as linoleamide, oleamide, and lauramide; saturated fatty acid bisamides, such as methylene bis(stearamide), ethylene bis(capramide), ethylene bis(lauramide), and hexamethylene bis(stearamide); unsaturated fatty acid amides, such as ethylene bis(oleamide), hexamethylene bis(oleamide), N,N′-dioleyladipamide, and N,N′-dioleylsebacamide; aromatic bisamides, such as m-xylene bis(stearamide) and N,N′-distearylisophthalamide; fatty acid metal salts (generally called metallic soap), such as calcium stearate, calcium laurate, zinc stearate, and magnesium stearate; aliphatic hydrocarbon-based waxes grafted with vinyl-based monomers such as styrene or acrylic acid; partially esterified compounds produced from fatty acids and polyhydric alcohols, such as behenic acid monoglyceride; and methyl ester compounds with hydroxy groups produced by hydrogenation of vegetable fats and oils.

The amount of the wax is preferably 2.0 parts by mass or more and 30.0 parts by mass or less relative to 100 parts by mass of the binder resin.

### Charge Control Agent

The toner of the present invention may contain a charge control agent if necessary. The charge control agent contained in the toner can be a known agent, and particularly, a colorless aromatic carboxylic acid metal compound that enables the toner to be rapidly charged and to stably hold a constant amount of charge is preferred.

Negative charge control agents include salicylic acid metal compounds, naphthoic acid metal compounds, dicarboxylic acid metal compounds, polymeric compounds with sulfonic or carboxylic acid side chains, polymeric compounds with sulfonic acid salt or sulfonic ester side chains, polymeric compounds with carboxylic acid salt or carboxylic ester side chains, boron compounds, urea compounds, silicon compounds, and calixarene. The charge control agent may be added within toner particles or externally added to the toner particles.

The amount of the charge control agent added is preferably 0.2 part by mass or more and 10.0 parts by mass or less relative to 100 parts by mass of the binder resin.

### Inorganic Fine Powder

The toner of the present invention may include inorganic fine powder as needed in addition to the above-described fine particles (external additive). The inorganic fine powder may be added to the inside of the toner particles or mixed with the toner particles as an external additive. Silica is preferred as the external additive. The inorganic fine powder is preferably hydrophobized with a hydrophobizing agent, such as a silane compound, silicone oil, or their mixture.

When an external additive is used to improve flowability, inorganic fine powder with a specific surface area of 50 m²/g or more and 400 m²/g or less is preferred. For improving flowability and stabilizing durability, inorganic fine particles with a specific surface area within this range may be used in combination.

The amount of the inorganic fine powder is preferably 0.1 part by mass or more and 10.0 parts by mass or less relative to 100 parts by mass of the toner particles. When the proportion is in this range, the effect in terms of stability in duration is likely to be produced.

### Developer

Although the toner of the present invention can be used as a single-component developer, it may be mixed with a magnetic carrier to improve the dot reproductivity and thus used as a two-component developer, which is desirable in terms of consistently providing images for a long period.

Generally known magnetic materials can be used as the magnetic carrier, and examples include iron powder whose surface is oxidized or unoxidized, metal particles of iron, lithium, calcium, magnesium, nickel, copper, zinc, cobalt, manganese, chromium, or rare earth metals and their alloy particles, oxide particles, magnetic materials such as ferrite, and magnetic material-dispersed resin carriers (what are called resin carriers) containing a magnetic material and a binder resin holding the magnetic material in a dispersed state.

When the toner is mixed with a magnetic carrier to be used as a two-component developer, the proportion of the carrier to be mixed is preferably such that the toner content of the two-component developer is 2 mass % or more and 15 mass % or less, more preferably 4 mass % or more and 13 mass % or less. Such a proportion leads to a good result.

### Production Methods of Toner Particles and Toner

The toner particles can be produced by known methods without limitation, such as suspension polymerization, emulsion aggregation, melt-kneading, and dispersion suspension.

The external additive particles of the present invention and, optionally, other external additives may be added to the resulting toner particles to obtain a toner. For mixing the toner particles and the external additive particles of the present invention, mixing apparatuses may be used. These apparatuses include double-cone mixers, V-shaped mixers, drum mixers, super mixers, Henschel mixers, Nauta mixers, and Mechano Hybrid (manufactured by Nippon Coke & Engineering), and Nobilta (manufactured by Hosokawa Micron).

### Measurement Methods of Physical Properties

Measurement methods of physical properties will now be described.

### Separation of Fine Particles and Toner Particles From Toner

For measuring physical properties, the fine particles can be separated from the toner by the following method.

A concentrated sucrose solution is prepared by dissolving 200 g of sucrose (produced by Kishida Chemical) in 100 mL of ion-exchange water being heated in hot water. A dispersion liquid is prepared by adding 31 g of the concentrated sucrose solution and 6 mL of Contaminon N (10 mass % aqueous solution of pH 7 neutral detergent for cleaning precision measuring instruments, containing a nonionic surfactant, an anionic surfactant, and an organic builder, produced by Wako Pure Chemical Corporation) into a centrifuge tube. Then, 1 g of the toner is added into the dispersion liquid, followed by diffusing aggregates of the toner with a spatula or the like.

The centrifuge tube is shaken with a shaker for 20 minutes under the condition of reciprocally 350 times per minute. After shaking, the liquid is placed into a glass tube (50 mL) for a swing rotor and centrifuged at 3500 rpm for 30 minutes. After centrifugation, the toner in the glass tube is in the top layer, and the fine particles are in the aqueous solution of the lower layer. The aqueous solution of the lower layer is collected and centrifuged to separate sucrose and fine particles, and the fine particles are collected. If necessary, centrifugation is repeated. After sufficient separation, the dispersion liquid is dried, and fine particles are collected.

If a plurality of external additives are added, the external additive of the present invention can be separated using centrifugation or the like.

### Measurement Method of Number Average Diameter of Primary Particles of External Additive

The number average diameter of primary particles of the external additive can be measured by a centrifugal sedimentation method. Specifically, a solution was prepared by adding 0.2 g of 5% Triton solution and 19.8 g of RO water to 0.01 g of dried external additive particles in a 25 mL glass vial. Then, the resulting solution was subjected to dispersion at 20 W for 15 minutes using an ultrasonic dispersing machine with the probe (the very tip of the tip) immersed in the solution, thus obtaining a dispersion liquid. Subsequently, the number average diameter of the primary particles was measured using the resulting dispersion liquid with a centrifugal sedimentation particle size distribution analyzer DC24000, manufactured by CPS Instruments. The rotational speed of the disk was set at 18000 rpm, and the true density was set at 1.3 g/cm³. Before measurement, the analyzer was calibrated using polyvinyl chloride particles with an average particle diameter of 0.476 μm.

### Measurement Method of Embedding Rate of Fine Particles B

The external additive is sufficiently dispersed in a visible light-curable resin (Aronix LCR series D-800 (trade name) produced by Toagosei) and then cured by irradiation with short-wavelength light. The resulting cured product is cut out with an ultramicrotome equipped with a diamond knife to prepare a 250 nm-thick thin sample. Then, the cut sample is observed with a transmission electron microscope (JEM-2800 produced by JEOL) (TEM-EDX) at a magnification of 40000 to 50000 times, thus observing the cross section of the external additive. The diameter of the fine particles B and the depth of the fine particles B embedded in fine particles A are measured using the sectional image. Five fine particles B are randomly selected for one particle of the external additive, and the embedding rate of the fine particles B is calculated using the following equation. The number of external additive particles analyzed is 20 or more, and the average of their embedding rates is defined as the embedding rate of fine particles B.

$$Embedding rate ( \% ) of fine particles B = ( depth of fine particles B embedded in fine particles A / diameter of fine particles B ) \times 100$$

### Measurement of Volume Resistivity of External Additive

The volume resistivity of the external additive is measured as described below. Electrometer/High Resistance System Model 6517, manufactured by Keithley Instruments, is used as the apparatus. Electrodes of 25 mm in diameter are connected. Inorganic fine particles are placed to a thickness of about 0.5 mm between the electrodes, and the distance between the electrodes is measured with a load of about 2.0 N applied.

The resistance of the inorganic fine particles is measured with a voltage of 1, 000 V being applied for 1 minute, and the volume resistivity is calculated using the following equation:

$$Volume resistivity ( Ω \cdot cm ) = R \times L$$

R: resistance (Ω)
L: distance (cm) between electrodes

### Measurement Method of Volume Resistivity of Fine Particles B

First, the composition of fine particles B is identified. The measurement is conducted using a scanning electron microscope, “S-4800” (trade name, manufactured by Hitachi). Images with a distinct contrast between the portion derived from fine particles B, which are inorganic, and the portion derived from fine particles A, which are organic, are used as those of the external additive of the present invention, and images with no contrast are used as those of the external additive other than the external additive of the present invention. Inorganic fine particles B are observed with higher luminance. In the observation of the external additive, compositions of fine particles A and fine particles B are identified in a field of view magnified up to 2 million times using an energy-dispersive X-ray analyzer. After the identification of fine particles B, fine particles having the same composition as the fine particles B are prepared, and their volume resistivity is measured in the same manner as described above for the volume resistivity of the external additive. The resulting value is defined as the volume resistivity of the fine particles B.

### Measurement Method of Sb/Sa of External Additive

The cross section of the external additive is observed in the same manner as above, and the Sb/Sa of the external additive is calculated by image analysis. The image analysis software program is, for example, ImageJ. The area Sa of cross section X of an individual fine particle A is calculated from the image obtained by the observation, and the total area Sb of the fine particles B fully contained within cross section X without being exposed outside is calculated. The number of external additive particles analyzed is 100, and the average value is used as the Sb/Sa value in the present invention.

### Measurement Method of BD/AD of External Additive

The cross section of the external additive is observed in the same manner as above, and the BD/AD of the external additive is calculated. The particle diameter AD of fine particles A and the particle diameter BD of fine particles B are calculated from the image obtained by observation. The number of external additive particles analyzed is 20, and the average value is used as the BD/AD value in the present invention.

### Solid-State ²⁹Si-NMR Measurement Method of Proportions of Constituent Compounds in External Additive

In solid-state ²⁹Si-NMR, peaks are detected in different shift regions depending on the structure of the functional group bound to Si of the constituent compounds in the external additive. The structure bound to Si at each peak position is identified using reference samples. Also, the proportions of constituent compounds are calculated from the peak areas. These can be obtained by calculation of the ratios of the peak areas of M unit structure, D unit structure (c), T unit structure (b), and Q unit structure (a) to the total peak area.

Specific measurement conditions of solid-state ²⁹Si-NMR are as follows:
Apparatus: JNM-ECX 5002 (JEOL RESONANCE)
Temperature: room temperature
Measurement method: DDMAS method ²⁹Si 45°
Sample tube: zirconia, 3.2 mm in diameter
Sample: powder in the sample tube
Sample rotational speed: 10 kHz
Relaxation delay: 180 s
Scan: 2000

After the measurement, the silane components, different in substituent and linking group, in the sample are subjected to peak separation into the M unit structure, the D unit structure (unit (c)), the T unit structure (unit (b)), and the Q unit structure (unit a) by curve fitting, and their peak areas are calculated.

The curve fitting is performed using software for JNM-EX 400 manufactured by JEOL, EXcalibur for Windows (registered trademark) version 4.2 (EX series). Click “1D Pro” from the menu icon to load the measurement data. Then, select “Curve fitting function” from the “Command” menu bar for curve fitting. Perform curve fitting for each component so that the difference between the composite peak obtained by combining the peaks obtained by curve fitting and the peak of the measurement result (composite peak difference) is the smallest.

The proportion of the peak area of the structure represented by formula (a) relative to the total peak area of all silicon atoms in fine particles A is obtained as the proportion of the amount of unit (a) contained. Similarly, the peak areas of the structures represented by formulas (b) and (c) are obtained respectively, and the proportions of the amounts of units (b) and (c) contained are calculated using the respective peak areas. If the structures are required to be examined in more detail, identifications may be performed by combining the results of ¹³C-NMR and ¹H-NMR with the results of ²⁹Si-NMR.

### Measurement Method of True Specific Gravity of External Additive

The true specific gravity of the external additive was measured with a dry automatic density meter Autopycnometer (manufactured by Yuasa Ionics). The measurement conditions are as follows:
Cell: SM cell (10 mL)
Amount of sample: 0.05 g

This measurement method is intended to determine the true specific gravities of solids and liquids based on gas pycnometry. Gas pycnometry is based on Archimedes' principle as with liquid pycnometry and is more precise for very small pores because of the use of gas (argon gas) as the replacement medium.

### Measurement Method of Dielectric Constant of External Additive

The complex dielectric constant was measured at a frequency of 2 kHz using 284A Precision LCR Meter (manufactured by Hewlett-Packard) after being calibrated at frequencies of 1 kHz and 1 MHz. A load of 39200 kPa (400 kg/cm²) was applied to strontium titanate particles to be measured for 5 minutes to form a disk-shaped measurement sample with a diameter of 25 mm and a thickness of 1 mm or less (preferably 0.5 mm to 0.9 mm). This measurement sample is attached to ARES (manufactured by Rheometric Scientific F. E.) equipped with a dielectric constant measurement jig (electrode) with a diameter of 25 mm and measured at a frequency of 2 kHz in an atmosphere of 25° C. with a load of 0.49 N (50 g) applied.

### Measurement Method of Surface Treatment Agent of External Additive

The surface treatment agent of the external additive is analyzed by pyrolysis GC-MS (gas chromatograph-mass spectrometry).

Specific measurement conditions are as follows:
Apparatus: GC6890A (manufactured by Agilent), Pyrolyzer (manufactured by Japan Analytical Industry)
Column: HP-5 ms 30 m
Pyrolysis temperature: 590° C.

The peak positions in the profile obtained by the measurement are each identified using reference samples, thus identifying the surface treatment agent of the external additive.

### EXAMPLES

The present invention will be further described in detail with reference to the Examples described below. However, the Examples are not intended to limit the present invention. In the following description, “part(s)” is on a mass basis unless otherwise specified.

### Production Example of External Additive 1

### 1. Hydrolysis and Condensation Polymerization Step:

(1) Into a 500 mL beaker, 21.6 g of RO water, 135.0 g of methanol, 0.004 g of acetic acid as a catalyst, and 12.2 g of dimethyldimethoxysilane were added and stirred at 45° C. for 5 minutes.

(2) To the resulting mixture, 2.0 g of 28% ammonia water, 15.0 g of tetraethoxysilane, and 5.0 g of titanium oxide aqueous dispersion liquid A (40 mass % of titanium oxide solids, number average diameter of primary particles of titanium oxide: 28 nm) were added and stirred at 30° C. for 3.0 hours to yield a raw material solution.

### 2. Particle Formation Step:

RO water weighing 120. 0 g was poured into a 1000 mL beaker, and the raw material solution obtained in the above hydrolysis and condensation polymerization step was added over 5 minutes while the RO water was stirred at 25° C. Subsequently, the resulting mixture was heated to 60° C. and stirred for 1.5 hours with the temperature kept at 60° C. to yield a dispersion liquid of external additive fine particles.

### 3. Hydrophobization Step:

Hexamethyldisilazane weighing 6.0 g as a hydrophobizing agent was added to the dispersion liquid of the external fine particles obtained through the particle formation step and stirred at 60° C. for 3.0 hours. The dispersion liquid was left undisturbed for 5 minutes to allow the powder to settle to the bottom of the solution. The settled powder was collected by suction filtration and dried at 120° C. for 24 hours under reduced pressure to yield external additive 1. The number average diameter of primary particles of external additive 1 was 0.12 μm.

### Production Example of External Additive 2

External additive 2 was produced in the same manner as in the production example of external additive 1, except that in the hydrolysis and polycondensation step, the amount of dimethyldimethoxysilane was changed to 5.4 g in (1), the amount of tetraethoxysilane was changed to 8.2 g in (2), and 13.6 g of trimethoxymethylsilane was added.

### Production Example of External Additive 3

External additive 3 was produced in the same manner as in the production example of external additive 1, except that in the hydrolysis and polycondensation step, the amount of dimethyldimethoxysilane was changed to 8.2 g in (1), and the amount of tetraethoxysilane was changed to 19.0 g in (2).

### Production Example of External Additive 4

External additive 4 was produced in the same manner as in the production example of external additive 1, except that in the hydrolysis and polycondensation step, the amount of dimethyldimethoxysilane was changed to 21.8 g in (1), and the amount of tetraethoxysilane was changed to 5.4 g in (2).

### Production Example of External Additive 5

External additive 5 was produced in the same manner as in the production example of external additive 1, except that the amount of titanium oxide aqueous dispersion liquid A added was changed to 10.0 g in (2) of the hydrolysis and polycondensation step.

### Production Example of External Additive 6

External additive 6 was produced in the same manner as in the production example of external additive 1, except that the amount of titanium oxide aqueous dispersion liquid A added was changed to 15.0 g in (2) of the hydrolysis and polycondensation step.

### Production Example of External Additive 7

External additive 7 was produced in the same manner as in the production example of external additive 1, except that the hydrophobizing agent used was replaced with octamethylcyclotetrasiloxane in the hydrophobization step.

### Production Example of External Additive 8

External additive 8 was produced in the same manner as in the production example of external additive 1, except that the hydrophobizing agent used was replaced with chlorotrimethylsilane in the hydrophobization step.

### Production Example of External Additive 9

External additive 9 was produced in the same manner as in the production example of external additive 1, except that the hydrophobizing agent used was replaced with dimethylsilicone oil in the hydrophobization step.

### Production Example of External Additive 10

External additive 10 was produced in the same manner as in the production example of external additive 1, except for using no hydrophobizing agent in the hydrophobization step.

### Production Example of External Additive 11

External additive 11 was produced in the same manner as in the production example of external additive 1, except that the amount of titanium oxide aqueous dispersion liquid A added was changed to 17.5 g in (2) of the hydrolysis and polycondensation step.

### Production Example of External Additive 12

External additive 12 was produced in the same manner as in the production example of external additive 1, except that the amount of titanium oxide aqueous dispersion liquid A added was changed to 20.0 g in (2) of the hydrolysis and polycondensation step.

### Production Example of External Additive 13

External additive 13 was produced in the same manner as in the production example of external additive 12, except that the stirring time was changed to 3.5 hours in (2) of the hydrolysis and polycondensation step.

### Production Example of External Additive 14

External additive 14 was produced in the same manner as in the production example of external additive 13, except that the stirring temperature was changed to 35° C. in (2) of the hydrolysis and polycondensation step.

### Production Example of External Additive 15

External additive 15 was produced in the same manner as in the production example of external additive 1, except that strontium titanate aqueous dispersion liquid (40 mass % of strontium titanate solids, number average diameter of primary particles of strontium titanate: 40 nm (0.04 μm) was used instead of titanium oxide aqueous dispersion liquid A in (2) of the hydrolysis and polycondensation step.

### Production Example of External Additive 16

External additive 16 was produced in the same manner as in the production example of external additive 1, except that zinc oxide aqueous dispersion liquid (40 mass % of zinc oxide solids, number average diameter of primary particles of zinc oxide: 25 nm) was used instead of titanium oxide aqueous dispersion liquid A in (2) of the hydrolysis and polycondensation step.

### Production Example of External Additive 17

External additive 17 was produced in the same manner as in the production example of external additive 1, except that in (2) of the hydrolysis and polycondensation step, after 2.0 g of 28% ammonia water and 15.0 g of tetraethoxysilane were added and stirred at 30° C. for 3.0 hours, 5.0 g of titanium oxide aqueous dispersion liquid A was added, and the mixture was stirred at 30° C. for 10 minutes.

### Production Example of External Additive 18

External additive 18 was produced in the same manner as in the production example of external additive 14, except that the amount of titanium oxide aqueous dispersion liquid A added was changed to 5.0 g in (2) of the hydrolysis and polycondensation step.

### Production Example of External Additive 19

External additive 19 was produced in the same manner as in the production example of external additive 1, except that alumina aqueous dispersion liquid (40 mass % of alumina solids, number average diameter of primary particles of alumina: 25 nm) was used instead of titanium oxide aqueous dispersion liquid A in (2) of the hydrolysis and polycondensation step.

### Production Example of External Additive 20

External additive 20 was produced in the same manner as in the production example of external additive 1, except for the following in the hydrolysis and polycondensation step: the amount of dimethyldimethoxysilane was changed to 19.0 g in (1), the amount of tetraethoxysilane was changed to 8.2 g in (2), titanium oxide aqueous dispersion liquid B (40 mass % of titanium oxide solids, number average diameter of primary particles of titanium oxide: 15 nm) was used instead of titanium oxide aqueous dispersion liquid A, and the stirring temperature and time were changed to 25° C. and 2.0 hours, respectively.

### Production Example of External Additive 21

External additive 21 was produced in the same manner as in the production example of external additive 1, except that the hydrolysis and polycondensation step, titanium oxide aqueous dispersion liquid C (40 mass % of titanium oxide solids, number average diameter of primary particles of titanium oxide: 60 nm) was used instead of titanium oxide aqueous dispersion liquid A in (2) and the stirring time was changed to 3.5 hours.

### Production Example of External Additive 22

In a 250 mL round-bottom flask equipped with an overhead stirring motor, a condenser, and a thermocouple were added 30 g of titanium (IV) oxide nanopowder (200 m²/g specific surface area, particle diameter: less than 25 nm) and 150 mL of DI water. The pH of the resulting dispersion liquid was adjusted to 8.5 by adding several droplets of concentrated ammonium hydroxide aqueous solution. The dispersion liquid was subjected to ultrasonication with an ultrasonication device at a power of 30% for 10 minutes to ensure that titanium oxide was completely dispersed. Methacryloxypropyltrimethoxysilane (MPS) weighing 20 g (0.08 mol) was added, and the mixture was stirred at a speed of about 100 rpm with the temperature raised to 65° C. The mixture was bubbled for 30 minutes by introducing nitrogen gas into the mixture. After 3 hours, 0.2 g of 2,2′-azobisisobutyronitrile (AIBN) radical initiator dissolved in 10 mL of ethanol was added, and the temperature was raised to 75° C. Radical polymerization was allowed to proceed for 5 hours. The final mixture was filtered through a 170 mesh sieve to remove solidified matter, and the resulting dispersion liquid was dried at 120° C. in a Pyres (registered trademark) dish overnight, thus producing external additive 22.

### Production Example of External Additive 23

In an FM mixer “FM 10C/1” (manufactured by Nippon Coke & Engineering), 90 parts of polymethylsilsesquioxane fine particles (MSP-SN05, 0.5 μm number average diameter of primary particles, 280° C. or more melting temperature, 1.3 true specific gravity (produced by Nikko Rica Corporation)) was placed, and 10 parts of hydrophobic titanium dioxide fine particles (KT-1501, 15 nm number average diameter of primary particles, 58 hydrophobization degree (produced by K.K. Eiwa)), followed by mixing. HYDROGEN DIMETHICON “KF-9901 (produced by Shin-Etsu Chemical)” as silicone oil for hydrophobization was diluted to 40 mass % with isopropyl alcohol and used as a hydrophobization agent mixture. While the FM mixer was rotated at 2, 500 rpm, the hydrophobization agent mixture was sprayed onto the mixture of particles, followed by blending for 10 minutes. After adding the hydrophobization agent mixture, the resulting mixture was blended for 15 minutes to yield hydrophobized fine particles.

The hydrophobized fine particles were removed into a vat from the FM mixer and heat-treated at 180° C. for 3 hours in a shelf-type circulating hot air dryer. The resulting mixture of fine particles was crushed with the FM mixer “FM 10C/1” and then classified with an ultrasonic sieve “C-700C” (manufactured by Dalton Corporation) at 60 mesh to yield external additive 23.

The physical properties of the external additives 1 to 23 produced above are presented in Tables 1-1 and 1-2.

TABLE 1-1

| | | | | | True | | |
|---|---|---|---|---|---|---|---|
| | | | | | specific | Dielectric | |
| External | Particle size | Composition ratio | | | gravity | constant | |
| additive No. | μm | (a) | (b) | (c) | g/cm³ | pF/m | Surface treatment agent |
| External additive 1 | 0.12 | 0.40 | 0.00 | 0.60 | 1.35 | 25 | Hexamethyldisilazane |
| External additive 2 | 0.12 | 0.30 | 0.50 | 0.20 | 1.35 | 25 | Hexamethyldisilazane |
| External additive 3 | 0.10 | 0.70 | 0.00 | 0.30 | 1.35 | 25 | Hexamethyldisilazane |
| External additive 4 | 0.15 | 0.20 | 0.00 | 0.80 | 1.35 | 25 | Hexamethyldisilazane |
| External additive 5 | 0.12 | 0.40 | 0.00 | 0.60 | 1.40 | 20 | Hexamethyldisilazane |
| External additive 6 | 0.12 | 0.40 | 0.00 | 0.60 | 1.46 | 18 | Hexamethyldisilazane |
| External additive 7 | 0.12 | 0.40 | 0.00 | 0.60 | 1.35 | 25 | Octamethylcyclotetrasiloxane |
| External additive 8 | 0.12 | 0.40 | 0.00 | 0.60 | 1.35 | 25 | Chlorotrimethylsilane |
| External additive 9 | 0.12 | 0.40 | 0.00 | 0.80 | 1.35 | 25 | dimethyl silicone oil |
| External additive 10 | 0.12 | 0.40 | 0.00 | 0.60 | 1.35 | 25 | N/A |
| External additive 11 | 0.12 | 0.40 | 0.00 | 0.60 | 1.49 | 10 | Hexamethyldisilazane |
| External additive 12 | 0.12 | 0.40 | 0.00 | 0.80 | 1.56 | 8 | Hexamethyldisilazane |
| External additive 13 | 0.12 | 0.40 | 0.00 | 0.60 | 1.60 | 5 | Hexamethyldisilazane |
| External additive 14 | 0.12 | 0.40 | 0.00 | 0.60 | 1.70 | 3 | Hexamethyldisilazane |
| External additive 15 | 0.12 | 0.40 | 0.00 | 0.60 | 1.35 | 25 | Hexamethyldisilazane |
| External additive 16 | 0.12 | 0.40 | 0.00 | 0.60 | 1.35 | 25 | Hexamethyldisilazane |
| External additive 17 | 0.12 | 0.40 | 0.00 | 0.60 | 1.35 | 25 | Hexamethyldisilazane |
| External additive 18 | 0.11 | 0.40 | 0.00 | 0.60 | 1.35 | 3 | Hexamethyldisilazane |
| External additive 19 | 0.12 | 0.40 | 0.00 | 0.60 | 1.35 | 25 | Hexamethyldisilazane |
| External additive 20 | 0.35 | 0.30 | 0.00 | 0.70 | 1.35 | 25 | Hexamethyldisilazane |
| External additive 21 | 0.80 | 0.40 | 0.00 | 0.60 | 1.35 | 25 | Hexamethyldisilazane |
| External additive 22 | 0.12 | 0.00 | 0.00 | 0.00 | 2.50 | 8 | N/A |
| External additive 23 | 0.12 | 0.00 | 1.00 | 0.00 | 1.35 | 40 | Hexamethyldisilazane |

| | | Fine particles B | | | | |
|---|---|---|---|---|---|---|
| | | | Volume | Embedding | | |
| External | Fine | | resistivity | rate | | |
| additive No. | particles A | Type | Ω · m | % | BD/AD | Sb/Sa |
| External additive 1 | Organosilicon compound | Titanium oxide | 1.0 × 10¹¹ | 50 | 0.23 | 0.25 |
| External additive 2 | Organosilicon compound | Titanium oxide | 1.0 × 10¹¹ | 50 | 0.23 | 0.25 |
| External additive 3 | Organosilicon compound | Titanium oxide | 1.0 × 10¹¹ | 50 | 0.28 | 0.25 |
| External additive 4 | Organosilicon compound | Titanium oxide | 1.0 × 10¹¹ | 50 | 0.14 | 0.25 |
| External additive 5 | Organosilicon compound | Titanium oxide | 1.0 × 10¹¹ | 55 | 0.23 | 0.48 |
| External additive 6 | Organosilicon compound | Titanium oxide | 1.0 × 10¹¹ | 60 | 0.23 | 0.55 |
| External additive 7 | Organosilicon compound | Titanium oxide | 1.0 × 10¹¹ | 50 | 0.23 | 0.25 |
| External additive 8 | Organosilicon compound | Titanium oxide | 1.0 × 10¹¹ | 50 | 0.23 | 0.25 |
| External additive 9 | Organosilicon compound | Titanium oxide | 1.0 × 10¹¹ | 50 | 0.23 | 0.25 |
| External additive 10 | Organosilicon compound | Titanium oxide | 1.0 × 10¹¹ | 50 | 0.23 | 0.25 |
| External additive 11 | Organosilicon compound | Titanium oxide | 1.0 × 10¹¹ | 65 | 0.23 | 0.59 |
| External additive 12 | Organosilicon compound | Titanium oxide | 1.0 × 10¹¹ | 70 | 0.23 | 0.65 |
| External additive 13 | Organosilicon compound | Titanium oxide | 1.0 × 10¹¹ | 75 | 0.23 | 0.71 |
| External additive 14 | Organosilicon compound | Titanium oxide | 1.0 × 10¹¹ | 80 | 0.23 | 0.85 |
| External additive 15 | Organosilicon compound | Strontium | 1.0 × 10¹¹ | 50 | 0.33 | 0.25 |
| | | titanate | | | | |
| External additive 16 | Organosilicon compound | Zinc oxide | 1.0 × 10⁷ | 50 | 0.21 | 0.25 |
| External additive 17 | Organosilicon compound | Titanium oxide | 1.0 × 10¹¹ | 20 | 0.23 | 0.25 |
| External additive 18 | Organosilicon compound | Titanium oxide | 1.0 × 10¹¹ | 100 | 0.25 | 0.85 |
| External additive 19 | Organosilicon compound | Alumina | 1.0 × 10¹⁵ | 50 | 0.21 | 0.25 |
| External additive 20 | Organosilicon compound | Titanium oxide | 1.0 × 10¹¹ | 45 | 0.04 | 0.10 |
| External additive 21 | Organosilicon compound | Titanium oxide | 1.0 × 10¹¹ | 20 | 0.75 | 0.10 |
| External additive 22 | Resin | Titanium oxide | 1.0 × 10¹¹ | 50 | 0.23 | 0.85 |
| External additive 23 | Organosilicon compound | Titanium oxide | 1.0 × 10¹¹ | 0 | 0.23 | 0.00 |

TABLE 1-2

| | Relationship | Relationship | Relationship | Relationship | Relationship | Relationship |
|---|---|---|---|---|---|---|
| External additive No. | (1) | (2) | (I) | (II) | (III) | (IV) |
| External additive 1 | 1.00 | 0.60 | 0.40 | 0.00 | 0.60 | 1.00 |
| External additive 2 | 1.00 | 0.70 | 0.30 | 0.50 | 0.20 | 0.50 |
| External additive 3 | 1.00 | 0.30 | 0.70 | 0.00 | 0.30 | 1.00 |
| External additive 4 | 1.00 | 0.80 | 0.20 | 0.00 | 0.80 | 1.00 |
| External additive 5 | 1.00 | 0.60 | 0.40 | 0.00 | 0.60 | 1.00 |
| External additive 6 | 1.00 | 0.60 | 0.40 | 0.00 | 0.60 | 1.00 |
| External additive 7 | 1.00 | 0.60 | 0.40 | 0.00 | 0.60 | 1.00 |
| External additive 8 | 1.00 | 0.60 | 0.40 | 0.00 | 0.60 | 1.00 |
| External additive 9 | 1.00 | 0.60 | 0.40 | 0.00 | 0.60 | 1.00 |
| External additive 10 | 1.00 | 0.60 | 0.40 | 0.00 | 0.60 | 1.00 |
| External additive 11 | 1.00 | 0.60 | 0.40 | 0.00 | 0.60 | 1.00 |
| External additive 12 | 1.00 | 0.60 | 0.40 | 0.00 | 0.60 | 1.00 |
| External additive 13 | 1.00 | 0.60 | 0.40 | 0.00 | 0.60 | 1.00 |
| External additive 14 | 1.00 | 0.60 | 0.40 | 0.00 | 0.60 | 1.00 |
| External additive 15 | 1.00 | 0.60 | 0.40 | 0.00 | 0.60 | 1.00 |
| External additive 16 | 1.00 | 0.60 | 0.40 | 0.00 | 0.60 | 1.00 |
| External additive 17 | 1.00 | 0.60 | 0.40 | 0.00 | 0.60 | 1.00 |
| External additive 18 | 1.00 | 0.60 | 0.40 | 0.00 | 0.60 | 1.00 |
| External additive 19 | 1.00 | 0.60 | 0.40 | 0.00 | 0.60 | 1.00 |
| External additive 20 | 1.00 | 0.70 | 0.30 | 0.00 | 0.70 | 1.00 |
| External additive 21 | 1.00 | 0.60 | 0.40 | 0.00 | 0.60 | 1.00 |
| External additive 22 | 0.00 | 0.00 | 0.00 | 0.00 | 0.00 | 0.00 |
| External additive 23 | 1.00 | 1.00 | 0.00 | 1.00 | 0.00 | 0.00 |

### Production Example of Polyester Resin A1

Polyoxypropylene (2.2)-2,2-bis(4-hydroxyphenyl)propane: 76.9 parts (0.167 part by mole)
Terephthalic acid (TPA): 25.0 parts (0.145 part by mole)
Adipic acid: 8.0 parts (0.054 part by mole)
Titanium tetrabutoxide: 0.5 part

The above materials were added into a 4 L four-neck glass flask, and the flask was placed in a heating mantle equipped with a thermometer, a stirring bar, a condenser, and a nitrogen inlet. After the flask was purged with nitrogen gas, the contents of the flask were gradually heated with stirring and allowed to react with stirring at 200° C. for 4 hours (first reaction step). Then, 1.2 parts (0.006 part by mole) of trimellitic anhydride (TMA) was added, and the contents of the flask were allowed to react at 180° C. for 1 hour (second reaction step), thus obtaining polyester resin A1, which is a binder resin component. The acid value of this polyester resin A1 was 5 mg KOH/g.

### Production Example of Polyester Resin A2

Polyoxypropylene (2.2)-2,2-bis(4-hydroxyphenyl)propane: 71.3 parts (0.155 part by mole)
Terephthalic acid: 24.1 parts (0.145 part by mole)
Titanium tetrabutoxide: 0.6 part

The above materials were added into a 4 L four-neck glass flask, and the flask was placed in a heating mantle equipped with a thermometer, a stirring bar, a condenser, and a nitrogen inlet. After the flask was purged with nitrogen gas, the contents of the flask were gradually heated with stirring and allowed to react with stirring at 200° C. for 2 hours. Then, 5.8 parts (0.030 part by mole) of trimellitic anhydride was added, and the contents of the flask were allowed to react at 180° C. for 10 hours, thus obtaining polyester resin A2, which is a binder resin component. The acid value of this polyester resin A2 was 10 mg KOH/g.

### Production Example of Toner Particles 1

Polyester resin A1: 70.0 parts
Polyester resin A2:30.0 parts
Fischer-Tropsch wax (maximum endothermic peak temperature: 78° C.): 5.0 parts
C.I. Pigment Blue 15:3: 5.0 parts
Aluminum 3,5-di-t-butylsalicylate: 0.1 part

The raw materials presented above were mixed at a rotational speed of 20 s⁻¹ for 5 minutes using a Henschel mixer (FM-75, manufactured by Nippon Coke & Engineering), and then the mixture was kneaded in a twin screw kneader (PCM-30, manufactured by Ikegai) at a temperature of 125° C. and a rotational speed of 300 rpm. The resulting kneaded material was cooled and roughly crushed to a diameter of 1 mm or less with a hammer mill. The resulting crushed material was further pulverized to still smaller particle sizes with a mechanical pulverizer (T-250, manufactured by Freund-Turbo Corporation). Furthermore, the pulverized material was classified with a rotational classifier 200TSP (manufactured by Hosokawa Micron) to yield toner particles 1. The rotational classifier (200TSP, manufactured by Hosokawa Micron) was operated at a classification rotor rotational speed of 50.0 s⁻¹. The weight average particle diameter (D4) of the resulting toner particles 1 was 5.9 μm.

### Production Example of Toner 1

Toner particles 1:100 parts
External additive 1:6.0 parts

The materials presented above were mixed at a rotational speed of 30 s⁻¹ for 10 min using a Henschel mixer FM-10C (manufactured by Nippon Coke & Engineering) to yield toner 1.

### Production Examples of Toners 2 to 27

Toners 2 to 27 were produced in the same manner as in the production example of toner 1, except that the external additive and its amount added were varied, as presented in Table 2.

TABLE 2

| Toner No. | External additive No. | Amount (mass parts) |
|---|---|---|
| Toner 1 | External additive 1 | 6.0 |
| Toner 2 | External additive 1 | 0.1 |
| Toner 3 | External additive 1 | 20.0 |
| Toner 4 | External additive 1 | 0.05 |
| Toner 5 | External additive 1 | 25.0 |
| Toner 6 | External additive 2 | 6.0 |
| Toner 7 | External additive 3 | 6.0 |
| Toner 8 | External additive 4 | 6.0 |
| Toner 9 | External additive 5 | 6.0 |
| Toner 10 | External additive 6 | 6.0 |
| Toner 11 | External additive 7 | 6.0 |
| Toner 12 | External additive 8 | 6.0 |
| Toner 13 | External additive 9 | 6.0 |
| Toner 14 | External additive 10 | 6.0 |
| Toner 15 | External additive 11 | 6.0 |
| Toner 16 | External additive 12 | 6.0 |
| Toner 17 | External additive 13 | 6.0 |
| Toner 18 | External additive 14 | 6.0 |
| Toner 19 | External additive 15 | 6.0 |
| Toner 20 | External additive 16 | 6.0 |
| Toner 21 | External additive 17 | 6.0 |
| Toner 22 | External additive 18 | 6.0 |
| Toner 23 | External additive 19 | 6.0 |
| Toner 24 | External additive 20 | 6.0 |
| Toner 25 | External additive 21 | 6.0 |
| Toner 26 | External additive 22 | 6.0 |
| Toner 27 | External additive 23 | 6.0 |

### Production Example of Carrier 1

Magnetite 1 with a number average particle diameter of 0.30 μm (magnetization intensity under a magnetic field of 1000/4π (kA/m): 65 Am²/kg)
Magnetite 2 with a number average particle diameter of 0.50 μm (magnetization intensity under a magnetic field of 1000/4π (kA/m): 65 Am²/kg)

The fine particles of each of the above materials were treated by adding 4.0 parts of a silane compound ([3-(2-aminoethylamino)propyl]trimethoxysilane) to 100 parts of the material and blending the mixture by high-speed stirring at 100° C. or more in a vessel.
Phenol: 10 mass %
Formaldehyde solution: 6 mass % (40 mass % of formaldehyde, 10 mass % of methanol, 50 mass % of water)
Magnetite 1 treated with the above silane compound: 58 mass %
Magnetite 2 treated with the above silane compound: 26 mass %

In a flask were placed 100 parts of the above materials, 5 parts of 28 mass % ammonia solution, and 20 parts of water, and the temperature was raised to 85° C. over 30 minutes with stirring and mixing. With the temperature held, a polymerization reaction was performed for 3 hours to cure the phenolic resin that was produced. After the cured phenolic resin was cooled to 30° C., water was added to the resin, and then the supernatant liquor was removed. The sediment was rinsed with water and dried in the air. Then, the resulting substance was dried at 60° C. under reduced pressure (5 mmHg or less) to yield spherical carrier 1 with dispersed magnetic material. The volume average median particle diameter (D50) was 34.2 μm.

### Production Example of Two-Component Developer 1

Two-component developer 1 was produced by adding 8.0 parts of toner 1 to 92.0 parts of carrier 1 and mixing the materials with a V-blender (V-20, manufactured by Seishin Enterprise).

### Production Examples of Two-Component Developers 2 to 27

Two-component developers 2 to 27 were prepared in the same manner as in the production example of two-component development 1, except that the toner was replaced with toners 2 to 27, respectively.

### Examples 1 to 20, Comparative Examples 1 to 7

The toners 1 to 27 and two-component developers 1 to 27 were evaluated for performance using an actual apparatus.

### Toner Evaluation Method

A printer modified from a digital printer for commercial printing, imagePRESS C810, manufactured by Canon, was used as the image-forming apparatus, and the two-component developer was placed in the cyan developer. The apparatus was modified to allow the fixing temperature, the process speed, the DC voltage VDC of the developer bearing member, the charging voltage VD of the electrostatic latent image bearing member, and the laser power to be set freely. For image output evaluation, an FFh image (solid image) with a desired image ratio was output. The VDC, VD, and laser power were adjusted so that the amount of toner on the FFh image on paper would be as desired, and the examinations described below were conducted.

FFh refers to a value of 256 gradations expressed in hexadecimal notation; 00h represents the first gradation (blank) of the 256 gradations; and FFh represents the 256th gradation (solid) of the 256 gradations.

Evaluation was conducted using the following examination methods, and the results are presented in Table 3.

### (1) Examination of Changes in Adhesion (Low-Humidity Environments)

A full-color copier imagePress C800, manufactured by Canon, was used as an image-forming apparatus. The two-component developer was placed in the cyan developer of the image-forming apparatus, and the toner was placed in the cyan toner container. The examination described below was thus conducted. The apparatus was modified to remove the mechanism for discharging the excess magnetic carrier left within the developer from the developer. Plain paper sheets GF-C081 (A4, 81.4 g/m² basis weight, available from Canon Marketing Japan) were used for the examination.

The amount of toner on the FFh image (solid image) on the paper sheet was adjusted to 0.45 mg/cm². FFh refers to a value of 256 gradations expressed in hexadecimal notation; 00h represents the first gradation (blank) of the 256 gradations; and FFh represents the 256th gradation (solid) of the 256 gradations.

First, images were output at an image ratio of 1% on 1,000 sheets for image output examination. During the continuous feeding of 1,000 sheets, the sheets were fed under the same development conditions and transfer conditions (no calibration) as the first sheet.

Then, images were output at an image ratio of 80% on 1,000 sheets for image output examination. During the continuous feeding of 1,000 sheets, the sheets were fed under the same development conditions and transfer conditions (no calibration) as the first sheet.

The initial density was defined as the density of the 1,000th image in the printing at an image ratio of 1%, and the density of the 1,000th image in the printing at an image ratio of 80% was measured and evaluated according to the following evaluation criteria.

The above examination was conducted at a normal-temperature, low-humidity environment (N/L, 23° C. temperature, 5% relative humidity).

The initial density and the density of the 1,000th image in the printing at an image ratio of 80% were measured using an X-Rite color reflection densitometer (500 series, manufactured by X-Rite) and rated according to the following criteria. When the rating was D or greater, it was determined that the effect of the present invention was obtained.

### Evaluation Criteria, Difference in Density

A: Less than 0.02
B: 0.02 or more and less than 0.05
C: 0.05 or more and less than 0.10
D: 0.10 or more and less than 0.15
E: 0.15 or more and less than 0.20
F: 0.20 or more

### (2) Examination of Charge Retention Rate (High-Temperature, High-Humidity Environments)

The toner weighing 0.01 g was placed in an aluminum pan and charged to −600 V with a corona charger (trade name: KTB-20, manufactured by Kasuga Denki, Inc.) Subsequently, changes in surface potential were measured for 30 minutes in a high-temperature, high-humidity environment (H/H, 30° C. temperature, 80% humidity) using a surface potential meter (model 347, manufactured by Trek Japan).

The charge retention rate was calculated using the measurement results. The chargeability was evaluated based on the charge retention rate. When the rating was G or greater, it was determined that the effect of the present invention was obtained.

$$Charge retention rate ( \% ) after 30 minutes = ( surface potential after 30 minutes / initial surface potential ) \times 100$$

### Evaluation Criteria

A: Charge retention rate of 98% or more
B: Charge retention rate of 95% or more and less than 98%
C: Charge retention rate of 90% or more and less than 95%
D: Charge retention rate of 85% or more and less than 90%
E: Charge retention rate of 80% or more and less than 85%
F: Charge retention rate of 75% or more and less than 80%
G: Charge retention rate of 70% or more and less than 75%
H: Charge retention rate of less than 70%

TABLE 3

| | | N/L Adhesion change | | H/H Chargeability | |
|---|---|---|---|---|---|
| | | Density | | Value | |
| | Two-component developer No. | difference | Rating | (%) | Rating |
| Example 1 | Two-component developer 1 | 0.01 | A | 99 | A |
| Example 2 | Two-component developer 2 | 0.03 | B | 98 | A |
| Example 3 | Two-component developer 3 | 0.01 | A | 96 | B |
| Example 4 | Two-component developer 4 | 0.05 | C | 98 | A |
| Example 5 | Two-component developer 5 | 0.01 | A | 91 | C |
| Example 6 | Two-component developer 6 | 0.03 | B | 98 | A |
| Example 7 | Two-component developer 7 | 0.01 | A | 96 | B |
| Example 8 | Two-component developer 8 | 0.01 | A | 92 | C |
| Example 9 | Two-component developer 9 | 0.04 | B | 97 | B |
| Example 10 | Two-component developer 10 | 0.04 | B | 93 | C |
| Example 11 | Two-component developer 11 | 0.01 | A | 98 | A |
| Example 12 | Two-component developer 12 | 0.01 | A | 98 | A |
| Example 13 | Two-component developer 13 | 0.07 | C | 98 | A |
| Example 14 | Two-component developer 14 | 0.11 | D | 95 | B |
| Example 15 | Two-component developer 15 | 0.06 | C | 89 | D |
| Example 16 | Two-component developer 16 | 0.07 | C | 83 | E |
| Example 17 | Two-component developer 17 | 0.07 | C | 79 | F |
| Example 18 | Two-component developer 18 | 0.08 | C | 74 | G |
| Example 19 | Two-component developer 19 | 0.01 | A | 98 | A |
| Example 20 | Two-component developer 20 | 0.01 | A | 98 | A |
| Comparative Example 1 | Two-component developer 21 | 0.15 | E | 98 | A |
| Comparative Example 2 | Two-component developer 22 | 0.08 | C | 65 | H |
| Comparative Example 3 | Two-component developer 23 | 0.18 | E | 98 | A |
| Comparative Example 4 | Two-component developer 24 | 0.19 | E | 98 | A |
| Comparative Example 5 | Two-component developer 25 | 0.23 | F | 91 | C |
| Comparative Example 6 | Two-component developer 26 | 0.09 | C | 66 | H |
| Comparative Example 7 | Two-component developer 27 | 0.24 | F | 99 | A |

The external additive of the present invention, when used, can reduce changes in charge in low-humidity environments and suppress the increase in electrostatic adhesion.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An external additive for toner comprising:
fine particles A containing an organosilicon compound with a siloxane bond as a binder component and having fine particles B,
the fine particles B being present at the surface of the fine particles A in a state at least partially embedded in the surface of the fine particles A,
wherein the external additive has a number average diameter of primary particles of 0.03 μm or more and 0.30 μm or less,
wherein the fine particles A contain units (a), (b), and (c), presented below, in proportions satisfying the following relationships (1) and (2) relative to all of the silicon atoms in the fine particles A, on a number basis:
$$( a ) + ( b ) + ( c ) \geq 0.8 \qquad ( 1 )$$
$$( b ) + ( c ) \geq 0.3 \qquad ( 2 )$$
wherein the ratio BD/AD of the number average diameter BD of primary particles of the fine particles B to the number average diameter AD of primary particles of the fine particles A is 0.05 or more and 0.70 or less, and
wherein the fine particles B have a volume resistivity of 1.0×10⁵ Ω·cm or more and 1.0×10¹³ Ω·cm or less and have an embedding rate of 30% or more and 90% or less, the embedded rate being expressed as the following equation:
$$Embedding rate ( \% ) of fine particles B = ( depth of fine particles B embedded in fine particles A / diameter of fine particles B ) \times 100 ,$$ 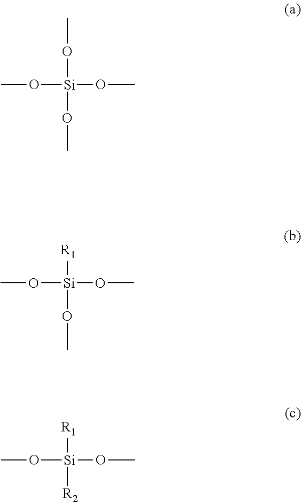
wherein R₁ and R₂ each independently represent an alkyl group with 1 to 6 carbon atoms.

2. The external additive for toner according to claim 1, wherein the fine particles B are at least one type of fine particles selected from the group consisting of titanium oxide fine particles, strontium titanate fine particles, and zinc oxide fine particles.

3. The external additive for toner according to claim 1, wherein the external additive has a true specific gravity of 1.00 g/cm³ or more and 1.60 g/cm³ or less.

4. The external additive for toner according to claim 1, wherein the external additive has a dielectric constant of 10 pF/m or more and 40 pF/m or less at 2 kHz.

5. The external additive for toner according to claim 1, wherein the external additive is surface treated with at least one compound selected from the group consisting of alkylsilazane compounds, alkylalkoxysilane compounds, chlorosilane compounds, and silicone oil.

6. The external additive for toner according to claim 1, wherein when an electron micrograph of cross sections of the fine particles A is taken using a transmission electron microscope, the average of Sb/Sa values of 100 fine particles A is 0 or more and 0.50 or less, wherein Sa is the area of cross section X of an individual fine particle A, and Sb is the total area of the fine particles B fully contained within the cross section X without being exposed outside.

7. The external additive for toner according to claim 1, wherein the proportion of the amounts of the units (a), (b), and (c) in the fine particles A, on a number basis, satisfy the following relationships (I), (II), and (III):
$$0.3 \leq ( a ) / ( ( a ) + ( b ) + ( c ) ) \leq 0.7 \qquad ( I )$$
$$0 \leq ( b ) / ( ( a ) + ( b ) + ( c ) ) \leq 0.5 \qquad ( II )$$
$$0.2 \leq ( c ) / ( ( a ) + ( b ) + ( c ) ) \leq 0.7 . \qquad ( III )$$

8. The external additive for toner according to claim 1, wherein the proportions of the amounts of the units (a), (b), and (c) in the fine particles A, on a number basis, satisfy the following relationship (IV):
$$0.95 \leq ( ( a ) + ( c ) ) / ( ( a ) + ( b ) + ( c ) ) . \qquad ( IV )$$

9. A toner comprising: toner particles; and the external additive for toner according to claim 1.

10. The toner according to claim 9, wherein the amount of the external additive for toner is 0.1 part by mass or more and 20.0 parts by mass or less relative to 100 parts by mass of the toner particles.
